(19) United States
(12) Patent Application Publication
(10) Pub. No.: US 2004/0252454 A1
(43) Pub. Date: Dec. 16, 2004

(54) Laptop computer heat dissipator

(75) Inventor: Vincent Chen, Taipei Hsien (TW)

Correspondence Address: Cooper & Dunham LLP, 1185 Avenue of the Americas, New York, NY, 10036, US

(73) Assignee: Auras Technology Ltd.

(21) Appl. No.: 10/462,536

(22) Filed: Jun. 16, 2003

(51) Int. Cl. G06F 1/20

(52) U.S. Cl. 361/687; 361/708; 361/700

(57) ABSTRACT

A laptop computer heat dissipator includes a casing mounted under the laptop computer for receiving therein a circuit board. The casing has a chamber defined inside the casing to receive therein a phase change material. When the phase change material encounters heat from the circuit board, a portion of the phase change material changes from solid to fluid while absorbing heat from surrounding environment.

### BACKGROUND OF THE INVENTION

1. Field of the Invention

The present invention relates to a heat dissipator, and more particularly to a laptop computer heat dissipator with which not only the generated heat from the circuit board is dissipated effectively, but also available space inside the laptop computer is increased.

2. Description of Related Art

Nowadays, because the world village concept is deeply reflected in our daily routine, mutual and real-time communication becomes even more important than ever. That is, to catch up with the sudden change of the mainstream of the world, more and more people use a laptop computer to communicate with others so that people can use the best out of the “instant info”.

When a user is using a laptop computer, normally the best support for the laptop computer is the user's laps. As a common knowledge to all the laptop computer users, the bottom of the laptop computer is the hottest place in the entire laptop computer in that the central processing unit (CPU) is located on top of a circuit board close to a bottom face of the laptop computer casing. When the CPU is running full speed, the generated heat has to be dissipated quickly and effectively otherwise other electrical components will be badly influenced by the heat. To cope with the heat, a heat dissipation fan is added into the compact space inside the casing of the laptop computer so that the heat can be blown away from the electrical components by the fan. However, after continuous operation for a period of time, the heat dissipation fan will be out of order eventually. By then, users will have to open the casing and replace the malfunctioned heat dissipation fan with a new one. The process of disassembling the casing alone is troublesome, let alone the money for a new heat dissipation fan.

To overcome the shortcomings, the present invention tends to provide an improved laptop computer heat dissipator to mitigate the aforementioned problems.

### SUMMARY OF THE INVENTION

The primary objective of the present invention is to provide an improved laptop computer heat dissipator with which expenses for replacing the heat dissipation fan is eliminated and available inside the casing is increased.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional view showing the structure of the invention; and

FIG. 2 is a schematic view showing that a circuit board is placed on top of the heat dissipator of the present invention.

### DETAILED DESCRIPTION OF THE PREFERRED EMBODIMENT

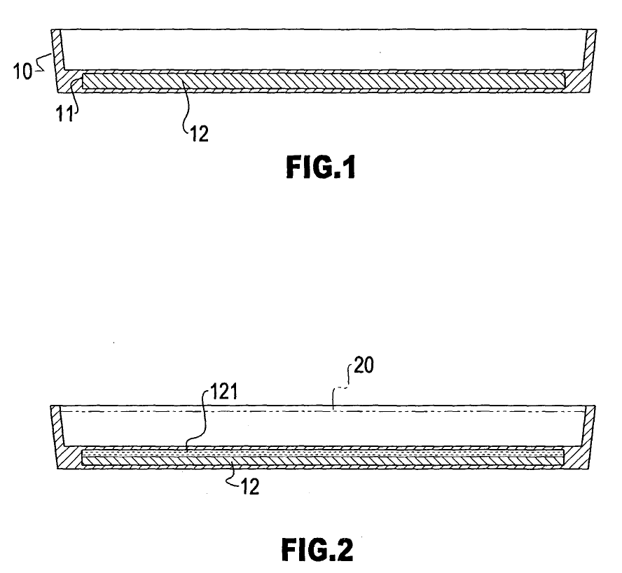

With reference to FIG. 1, the laptop computer heat dissipator in accordance with the present invention includes a casing (10) and a phase change material (12) (PCM) received in a chamber (11) defined in a bottom face of the casing (10). Preferably, the PCM material (12) is MgC₂6H₂O.

It is to be noted that when the PCM (12) is experiencing heat, the PCM (12) will undergo a phase change from solid to fluid. While the PCM (12) is changing from solid to fluid, the PCM (12) still sucks heat from the surrounding environment. Therefore, it is said that heat is the catalyst of phase change.

With reference to FIG. 2, when a circuit board (20) is placed on top of the casing (10) with the PCM (12) inside the casing (10), the heat generated from the circuit board (20) will influence a portion of the PCM (12) to change from solid to fluid. Because the PCM (12) is sealed inside the casing (10) in a watertight manner, a short by the PCM (12) in fluid type is avoided. With such an arrangement, the heat dissipation purposed is completed. Furthermore, due to the lack of the heat dissipation fan, the available space in the casing (10) is increased for the laptop designer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A laptop computer heat dissipator comprising a casing mounted under the laptop computer for receiving therein a circuit board, the casing having a chamber defined inside the casing to receive therein a phase change material in a watertight manner,
whereby when the phase change material encounters heat from the circuit board, a portion of the phase change material changes from solid to fluid while absorbing heat from surrounding environment.

2. The laptop computer heat dissipator as claimed in claim 1, wherein the phase change material is MgCl₂6H₂O.
